(19) United States
(12) Patent Application Publication
(10) Pub. No.: US 2018/0200910 A1
(43) Pub. Date: Jul. 19, 2018

(54) DEVICE WITH QUICK CHANGE BLADES, FOR TRANSVERSE CUTTING OR PERFORATION, FOR THE WHOLE OF THE WIDTH AND PROGRESSIVELY, OF MOVING WEBS OF PAPER, PLASTIC OR OTHER MATERIALS

(71) Applicant: CPS Company S.r.l., Casalecchio Di Reno, Province of Bologn (IT)

(72) Inventors: Stefano Cassoli, Casalecchio Di Reno (IT); Marco Cassoli, Casalecchio Di Reno (IT); Paolo Cassoli, Casalecchio Di Reno (IT)

(21) Appl. No.: 15/743,965

(22) PCT Filed: Jul. 5, 2016
(86) PCT No.: PCT/IB2016/054016

§ 371 Date: Jan. 11, 2018

(30) Foreign Application Priority Data
Jul. 22, 2015 (IT) 10201500036843

(51) Int. Cl. B26D 7/26; B26D 1/38; B26F 1/20

(52) U.S. Cl. CPC B26D 7/2614; B26D 1/385; B26D 2001/0073; B26F 1/20; B26D 7/2628

(57) ABSTRACT

There is described a device with quick change blades for the transverse cutting or perforation, for the whole of the width and progressively, of continuous and moving webs of paper, plastic or other materials, also with different thicknesses, wherein the fixed blade assembly and the rotary blade assembly are installed on the side members of a main base frame, with the drive means and with the means for adjusting the parallelism and the degree of interference between said two blades, said main base frame being installed removably on a secondary base frame, with means for adjusting the transverse alignment of the same main frame with the blade assemblies with respect to the longitudinal axis of the web to be cut, to allow dynamic execution on this web of a cut perpendicular to the longitudinal sides of the same web, this device being provided with means that allow quick installation and, when necessary, replacement with a new device each time both said blades require in-depth maintenance and adjustments, all for the purpose of limiting the downtimes of the packaging machine during replacement of the same device.

### CROSS-REFERENCE TO RELATED APPLICATIONS

The present application claims priority to PCT International Application No. PCT/IB2016/054016 filed on Jul. 5, 2016, which application claims priority to Italian Patent Application No. 102015000036843 (UB2015A002389) filed on Jul. 22, 2015, the entirety of the disclosures of which are expressly incorporated herein by reference.

### STATEMENT RE: FEDERALLY SPONSORED RESEARCH/DEVELOPMENT

Not Applicable

### BACKGROUND

The invention concerns a device with quick change blades for the transverse cutting or perforation, for the whole of the width and progressively, of continuous and moving webs of paper, plastic or other materials, to obtain therefrom sheets of the desired length, intended for a packaging machine, served by the device in question, together with means to support the reel from which said web is unwound and with means for feeding and guiding the same web to the cutting or perforation device. Hereunder in the description, for the sake of simplicity only for the cutting function of the device and its blades will be described, it being understood that the scope of protection also covers their perforation function, to make transverse perforation lines along which the web can be subsequently divided with a tearing operation. The cutting devices in question are usually provided with a fixed knife and a rotary knife, between which the continuous web to be cut dynamically is fed transversely. Devices of this kind are described in the German patent DE 4202186 A1 of 1992, which among other things illustrates how one or both the blades can be installed on a respective grooved supporting block, to form therewith a holder that can be inserted into and removed from corresponding supporting and blocking guides, to simplify and accelerate changing the worn blade with a new blade holder, ready for use.

The prior art patent U.S. Pat. No. 5,117,718 discloses arranging the fixed blade and the rotary blade transverse to the web to be cut so that the two blades are not parallel to each other but inclined, so that the cut is made by these blades on the whole of the width of the web and progressively, as if the cut were made by scissors. In this prior art solution, the inclined blade is the fixed one and at least this same blade is formed by a plurality of short blades positioned in an end-to-end relation, to together form a single fixed perforation blade that acts on the web for the whole of its width and that, viewed from the side, has a cutting edge in the form of a helix, to allow said progressive cut to be made with a scissor effect. With this solution it is possible to periodically replace only the most worn sections of blade, with understandable advantages during blade maintenance.

The prior art devices have complex structures and are difficult for the end user to perform maintenance on and adjust quickly, above all when both cutting blades require in-depth maintenance, and therefore a main aim of the invention consists in producing a cutting device in which both the blades, i.e. the fixed blade with rectilinear cutting edge and the rotary blade with helical cutting edge, are of the type with replaceable holder body and are installed on a single main base structure, where the fixed blade is positioned below the rotary blade and is provided with the necessary adjustments of interference with the same rotary blade, while said main base structure is designed for quick installation on a secondary base structure, for example on the base of the packaging machine, with the possibility of adjusting the transverse alignment, so that the inclined and progressive cut made on the moving web by the fixed blade assembly and the rotary blade assembly is perfectly perpendicular to the longitudinal sides of the same cut web.

### BRIEF SUMMARY

If the cutting device installed on a packaging machine should require a complex replacement and adjustment operation of both blades, the same device according to the invention can be quickly replaced with another spare device, reducing to a minimum the downtimes of the packaging machine, while the device removed can be subjected to all maintenance, adjustment and testing operations required to form a new spare device, ready for the next quick replacement of the one installed on the packaging machine.

### BRIEF DESCRIPTION OF THE DRAWINGS

Further features of the invention and the advantages deriving therefrom will be more apparent from the description below of a preferred embodiment of the invention, illustrated purely by way of non limiting example in the figures of the six accompanying drawings, wherein:

FIG. 1 is a perspective and overall view of the device, viewed from the side from which the web to be cut is fed in;

FIG. 2 illustrates the device of FIG. 1 in cross section;

FIG. 3 illustrates a front perspective view of the device only with the lower fixed blade and with the related double adjustment means;

FIG. 4 is a cross sectional view of the holder block with the fixed blade;

FIG. 5 is a perspective view of the lower part of the holder block with the fixed blade;

FIG. 6 illustrates details of the blocking system of the holder block with the fixed blade, viewed along the section line VI-VI of FIG. 2;

FIG. 7 is a perspective front view of the device with only the upper rotary blade;

FIG. 8 is a cross section of the holder block with the rotary blade;

FIG. 9 is a perspective view of the holder block with the rotary blade and which, as FIG. 8, shows the inclined and helical trend of the same rotary blade;

FIG. 10 schematically illustrates a plan view of the arrangement of the cutting blades of the device with respect to the continuous moving web to be cut and highlights the type of adjustment that must be imparted to these blades to ensure that the cut made by these is perpendicular to the longitudinal sides of the same web;

FIG. 11 illustrates a perspective enlarged view of the lower part of the main base structure that supports the blades, with adjustment means serving this main base and the lower blade and with the adjustments to modify the transverse alignment of the same main base in relation to the secondary base of the packaging machine.

### DETAILED DESCRIPTION

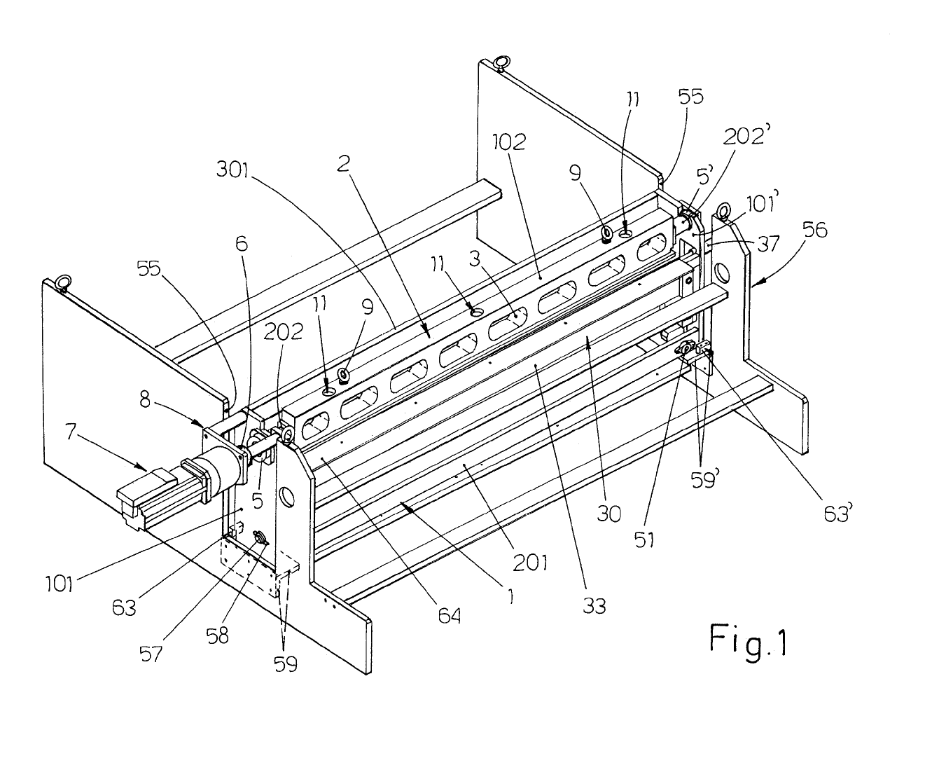

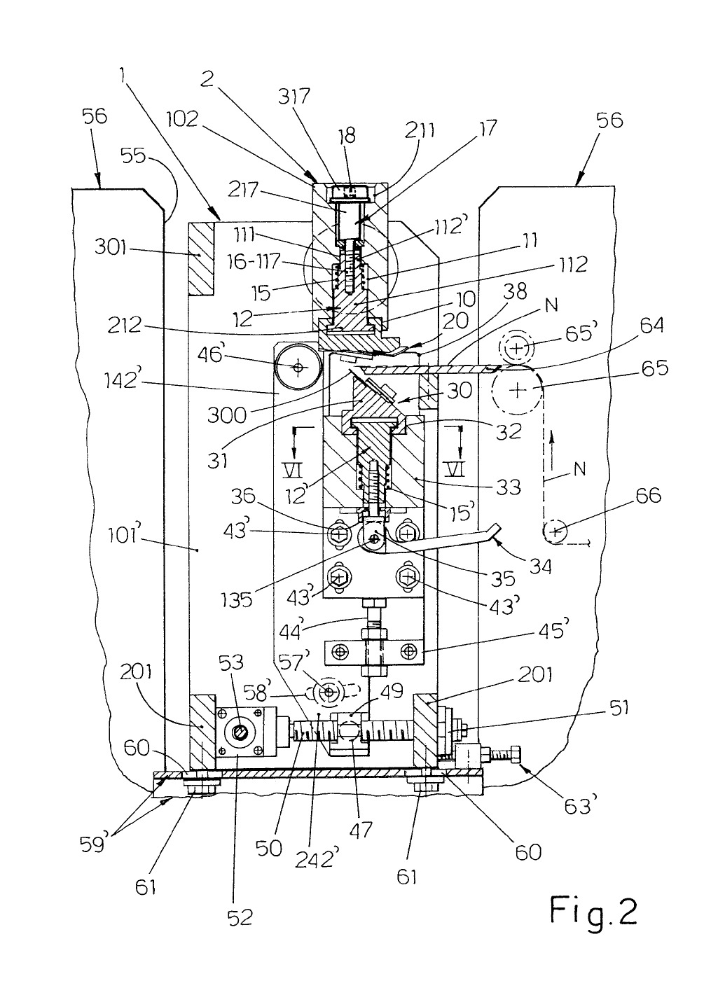

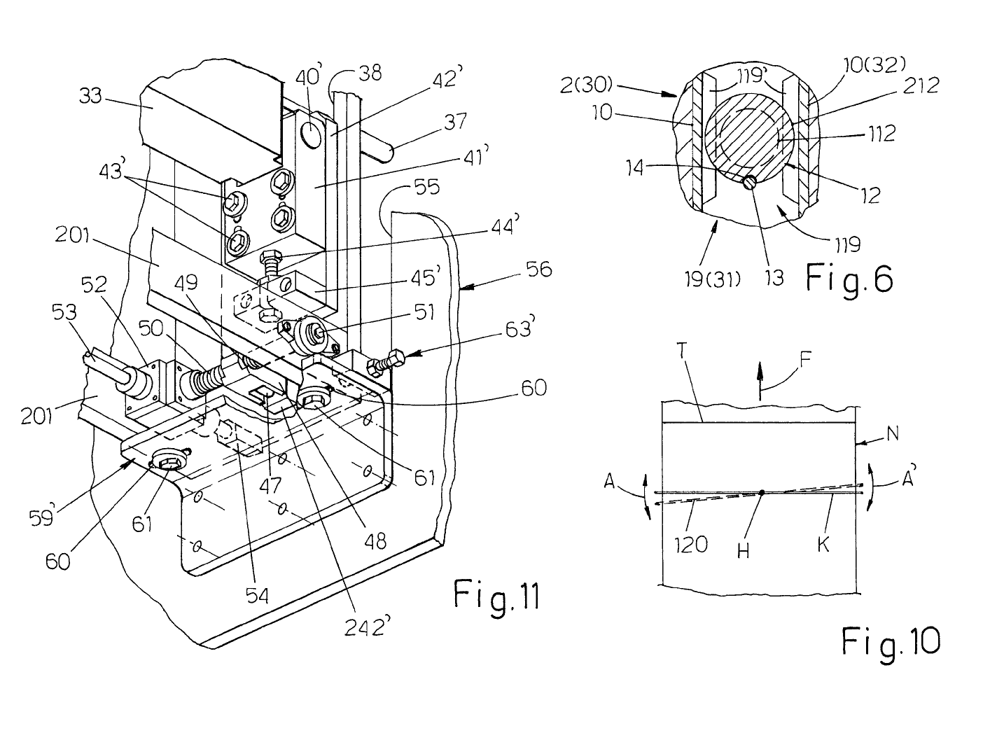

From FIGS. 1, 2, 3 and 7, it can be seen that the device comprises a main base frame 1 formed of rectangular side members 101, 101′, oriented with the larger dimension vertically and mutually fixed with at least a pair of lower cross members 201 and with at least an upper cross member 301 positioned laterally and parallel to the rotary blade assembly 2 that comprises a sturdy body 102 with a rectangular cross section, provided with transverse openings 3 for lightening the structure and for aerodynamic purposes and that carries, inserted on the ends, hubs 202, 202′ aligned with each other and with the longitudinal axis of the same body 102 that passes through slots 4, 4′ of the side members 101, 101′ on the outer side of which there are fixed the bearing cases 5, 5′ that support these hubs and one of which, 5, positioned on the left when viewing FIGS. 1 and 7, is open to allow connection of the hub 202, with interposing of a joint 6, to the output shaft of a gear motor 7 with electric motor for electronic speed and phase control, supported by a bracket 8 fixed on the outer side of the side member 101. The body 102 of the rotary blade assembly 2 is provided on one of the faces not affected by the openings 3, with at least a pair of symmetrical eyebolts 9 through which it is possible to move only the rotary blade assembly 2 or the whole base 1 with the rotary blade assembly and the fixed blade assembly, to be described below. The other face of the body 102 not affected by the eyebolts 9 (FIG. 2) is provided with a longitudinal channel 10 with U-shaped section, open on the centreline of the bottom of which are, for example, three transverse through holes 11, distributed symmetrically along the length of the same body 102 and sliding in these holes 11 is the shank 112 of respective mushroom shaped bolts 12, which with their round flat head 212 (see also FIG. 6) project inside the channel 10 to block the holder body of the rotary blade therein (see below). In FIG. 6 it can be seen that the head 212 of the bolts 12 is prevented from rotating by a pin 13 parallel thereto, planted in a hole provided in the centreline of the bottom of the channel 10 and the head 212 slides on this pin with a perimeter recess 14 thereof, so that the same head 212 does not rotate but can move freely in an axial direction.

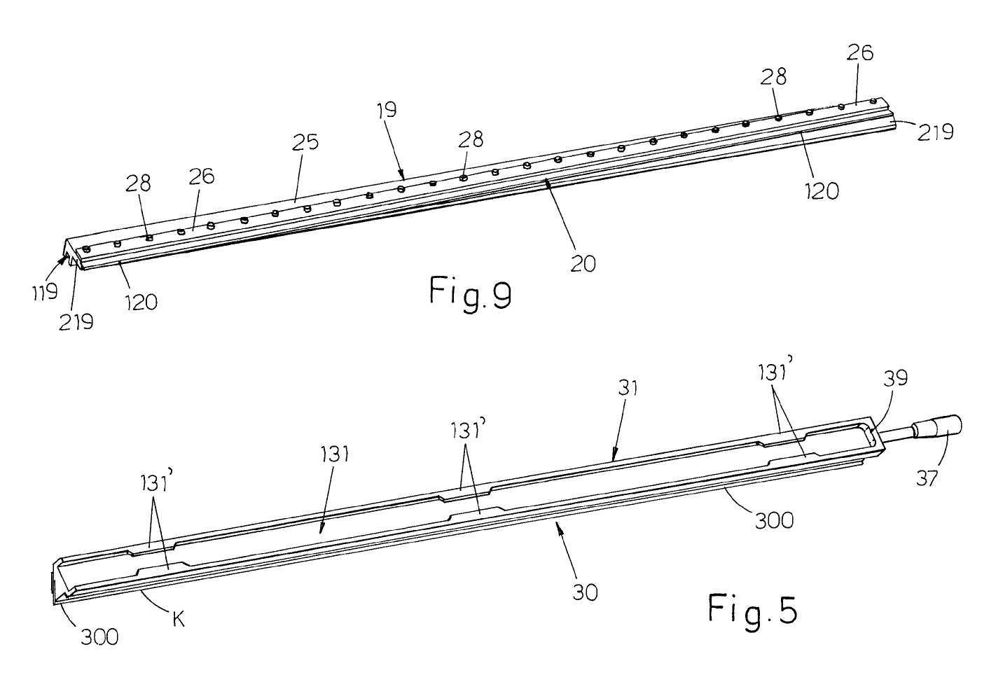

Again from the details of FIG. 1 it can be seen that the shank 112 of the bolts 12 has an end section of smaller diameter 112′ that slides in an intermediate section 111 of smaller diameter of the holes 11 and that with the initial part that is housed in the same holes 11, is struck by a cylindrical coil spring 15 that axially thrusts each bolt towards the channel 10. The section of smaller diameter 112′ of the shank of each bolt 12 is provided with a threaded axial hole 16 into which there is screwed the screw extension 117 of the shank of a counter-bolt 17, which with the portion of larger diameter 217 of the same shank housed is housed in the section of hole 11 that opens onto the face of the body 102 of the rotary knife provided with the eyebolts 9, with a widened section 211 in which there is housed and there rests as a result of the traction exerted by the spring 15, the head 317 of the same counter-bolt 17, which is designed to be rotated, for example, by means of a hexagonal wrench, as indicated by the axial socket 18 in FIG. 2. With reference also to FIG. 8, it can be seen that in the channel 10 there can be housed with high precision the lower and grooved part 119 of a metal bar that forms the body 19 of the holder block with the rotary blade, it being provided that this groove 119 has, for the majority of its extension, a U-shaped profile, illustrated in FIG. 5, for the body of the holder block of the fixed blade, to be described below, and which has a C-shaped profile 119′ only for small sections (see the sections 131′ for the holder block 31 of the fixed blade of FIG. 5), which are affected by the head 112 of the bolts 12, so that these small sections with C-shaped profile can be clamped by the same heads 112 when a screwing action is exerted on the counter-bolt 17.

By instead unscrewing the same counter-bolts 17 it is possible to loosen the grip of the heads 112 and to remove from or insert into the channel 10, the holder body 19 of the rotary blade. The grooved part 119 of the holder body 19 is provided with end of travel means for longitudinal insertion into the channel 10, analogous to those to be described below with reference to FIG. 5 for the fixed blade.

In FIGS. 8 and 9 it can be seen how the remaining part 219 of the holder body 19 is arranged to support with a partially cantilevered arrangement in the opposite direction to the direction of rotation of the body 102, an originally flat blade 20, the same length as the body 102, the projecting cutting edge 120 of which has a helical arrangement, with an inclination of around 20 degrees with respect to the ideal plane that contains the bottom of the groove 119, which is arranged on the lateral surface of an ideal cylinder having the rotation axis on that of the hubs 5, 5′) and the mid-point H of which lies on the centreline of the web N of paper to be cut, as schematically illustrated in FIG. 10, where the plan projection of the cutting edge of the same rotary blade is indicated with 120 and with a dashed line and where the plan projection of the cutting edge of the fixed blade, which passes through said mid-point H, is indicated with K and with a continuous line. The cutting edge 120 of the rotary blade 20 will start to cooperate with the cutting edge K of the fixed blade, for example starting from the left viewing FIG. 19 and will proceed progressively towards the right so as to make on the web N a cut T that will affect the same web for the whole of its width and that will be perfectly perpendicular to the sides of the same web N. As the web N moves in the direction indicated in FIG. 10 by the arrow F and as the cut T must be made on the same web N moving in the direction F, to avoid imperfections in making the same cut the correct relation between linear feed speed in the direction F and peripheral rotation speed of the cutting edge 120 of the rotary blade must be provided, and to ensure that the same cut T is perfectly perpendicular to the longitudinal axis of the web N, there will be provided adjustment means, described below with reference to FIGS. 1, 2 and 11, to adjust the alignment of the whole of the rotary blade assembly and the fixed blade assembly with rotation about a central point H, as indicated in FIG. 10 by the arrows A, A′.

In FIG. 9 it can be seen how said helical arrangement of the rotary blade 20 means that its cutting edge 120 starts by projecting from the left end of the rear side of the body 219 and how progressively, proceeding towards the right, the same cutting edge 120 is inclined and moved back transversely from the rear side of the same body 219.

The rotary blade 20 is formed by a rectangular steel strip, without holes and other fixing constraints, so that the same blade 20 can be arranged with both the longitudinal edges in the cutting function, so that when the exposed cutting edge 120 of the same blade is worn, the same blade can be reversed and installed with the other cutting edge opposite and parallel to the worn cutting edge exposed. From the details of FIG. 8 it can be seen that the body 219 has on the whole of its length an intermediate and helical flattened surface 21 and a subsequent helical and lowered flattened surface 22 on which there is arranged a strip of elastomeric material 23 that is arranged substantially coplanar to the flattened surface 21 and that together with this latter forms the support of the transversely unexposed section of the blade 20. The helical flattened surface 21 is preceded by another helical flattened surface 24 that is substantially coplanar with the exposed face of the blade 20 and that forms the abutment step for the non-operating edge of the same blade 20 and the flattened surface 24 is followed by a raised flattened surface 25 resting on which is the longitudinal side of a sturdy metal pressure plate 26 that pinches the blade 20 on the intermediate flattened surface 21 and to a lesser extent also on the insert 23, with interposing of an elastomeric strip 27 with greater rigidity than the insert 23. The flattened surface 24 is provided perpendicularly with a plurality of threaded holes distributed adequately space from one another on the whole of the body 219, and there are screwed into these holes the shanks of screws 28 that pass through corresponding through holes of the plate 26. Due to the presence of the inserts made of elastomeric material 23 and 27, the blade 20 can react in an elastic and non-traumatic way to the stresses deriving from cooperation with the fixed blade and with the web N to be cut.

In FIG. 8 the numeral 29 indicates the curved orbit with centre on the rotation axis 5, 5′ of the rotary blade assembly 2, lying on which orbit is the cutting edge 120 of the same rotary blade 20. On the point of this orbit 29 that lies on an ideal vertical plane containing the rotation axis of the same rotary blade 2, 20, point indicated with Z in the same FIG. 8, lies the cutting edge K (FIG. 10) of the fixed blade assembly 30, which will now be described with reference to FIGS. 1 to 6 and 11.

The assembly 30 comprises a flat rectangular blade 300, made of the same material as the rotary blade 20 considered previously, which forms with the orbit 29 of the same blade 20 an acute angle α, for example of around 45° and the cutting edge K of which is parallel to the rotation axis of the same blade 20. From the same FIGS. 1-6, it can be seen that the fixed blade 300 is supported by the inclined and composite plane of the holder body 31, the lower side of which has a grooved structure 131 as shown in FIG. 5, with sections 131′ with a C-shaped profile, which can be inserted with precision into the longitudinal channel 32 of a supporting body 33 that houses mushroom shaped clamping bolts 12′ with related counter spring 15′, similar to those 12 of the rotary blade 20, with respect to which the same bolts 12′ are differentiated by a different blocking and releasing solution that is obtained here by means of eccentric levers 34, articulated in 135 to the projecting end of a tie rod 35 fixed to the bolt 12′ and that cooperate with reaction surfaces 36 fixed to the lower face of the body 33, all so that by lifting said levers 34, the bolts 12′ are pulled downwards and the holder body 31 of the lower blade is blocked in its seat 32, while lowering the same levers 34 allows lifting of the bolts 12′ by the counter springs 15′, with consequent release of the stop through friction of the head of the same bolts 12′ on the parts 131′ with C-shaped profile of the holder body 31 of the lower blade. After release, the holder 31 with the blade 30 can be removed from the channel 32 that houses it. To facilitate insertion and removal of the holder 31 with the fixed blade 300 into and from the channel 32, there is provided integral with and cantilevered on the end of the same holder 31 that is inserted last into said channel 32, a handle 37 that projects from an opening 38 provided on the side member 101′ of the main base 1 (FIGS. 1, 2, 3, 7, 11), so that through the opening 38 it is possible to easily perform said operation of insertion and removal of the holder 31 with the lower blade 300. To allow correct positioning of the holder with the lower blade, the same holder 31 is provided, on the end of the channel 131 next to the handle 37 (FIG. 5), with a cross member 39 that cooperates with a stop provided on the proximal end of the guide channel 32. A similar solution is provided for the holder with the rotary blade 20, as indicated with 39′ in FIG. 8.

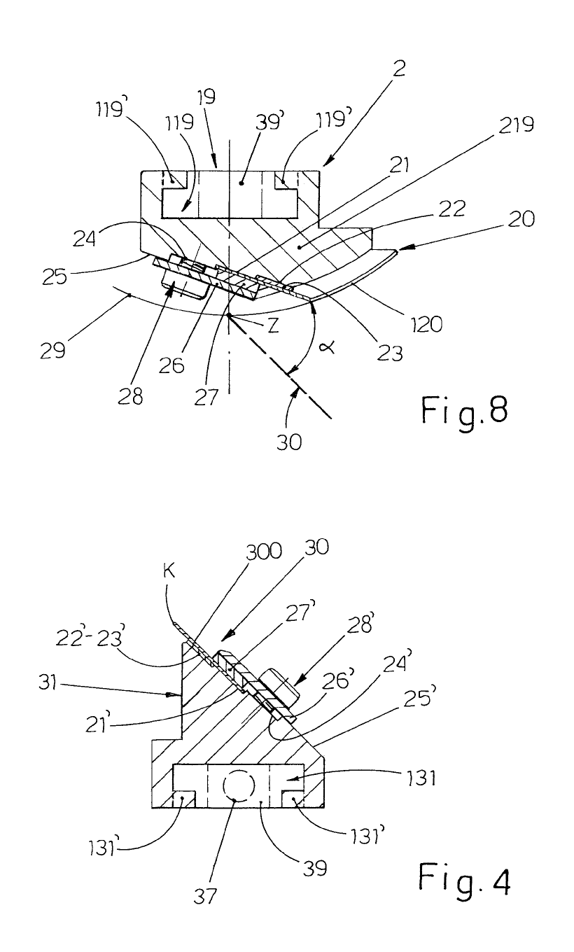

Fixing of the fixed blade 300 on the holder 31, illustrated in FIG. 4, is obtained with a solution analogous to that of the rotary blade, as can be clearly understood by comparing FIGS. 4 and 8, where the components of the solution of FIG. 4 are indicated with the same numbers as those of the solution of FIG. 8, with the addition of the “prime” exponent, bearing in mind that the various flattened surfaces for supporting the fixed blade 300 will now be rectilinear and not helical as those of FIG. 8 for the rotary blade.

To be able to produce the device with large operating tolerances and simultaneously allow positioning of the lower rectilinear blade 300 with high precision in relation to the upper rotary helical blade 20, it has been provided that the supporting body 33 of the fixed blade has end sections projecting from the holder 31 with the same fixed blade 300, provided with respective transverse horizontal holes to be able to be articulated through respective pins 40, 40′ to the upper end of corresponding vertical slides 41, 41′ installed on related outer supporting plates 42, 42′, with the possibility of independent and selective adjustment of the position in height of these slides 41, 41′, through guiding and blocking systems with slotted holes and screws 43, 43′ and by means of screw and lead screw height adjusters 44, 44′ that interact between the same slides 41, 41′ and the small brackets 45, 45′ below integral with said outer plates 42, 42′. With these independent adjustments it is possible to ensure a rigorously precise and “parallel”, or equidistant, arrangement between the rectilinear cutting edge K of the fixed blade 300 in relation to the plan projection of the helical cutting edge 120 of the rotary blade 20, even in the absence of high precision in the machining of the main frame 1, and in the installation thereon and in the mutual installation of all the parts that support the same fixed blade 300.

The invention also provides for the possibility of adjusting the degree of interference of the fixed blade 300 in relation to the rotary blade 20, to adapt the cutting system of webs of different thickness and materials and to take up the small amounts of wear that progressively occur on the two blades.

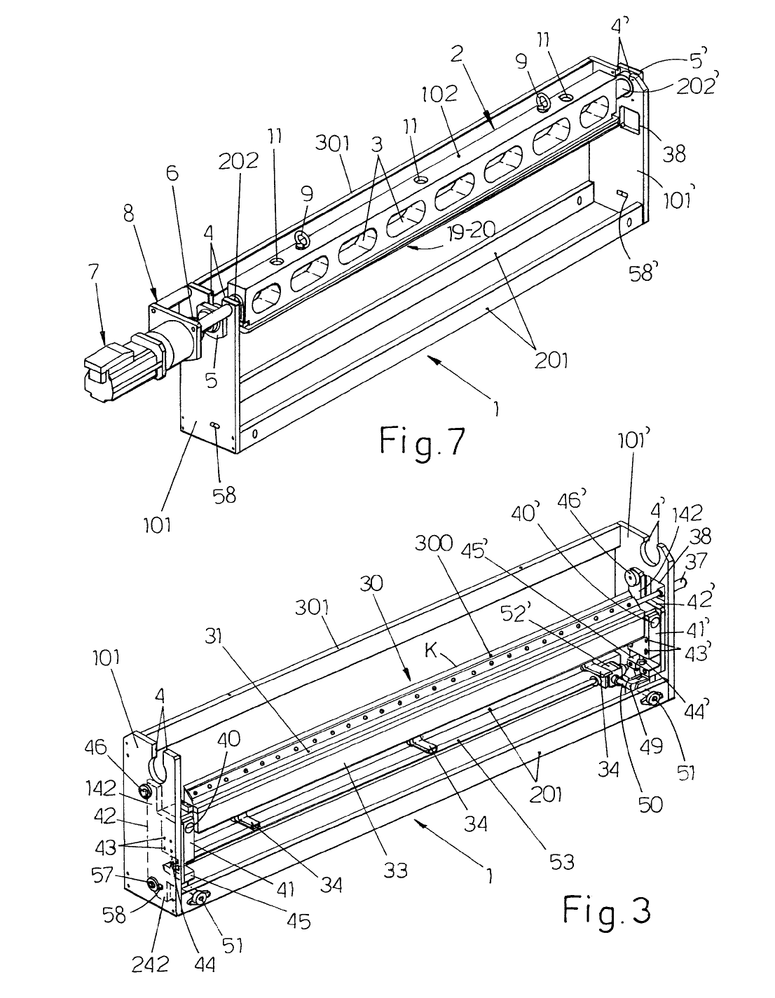

For this type of adjustment the outer plates 42, 42′ are provided, on the top part thereof, with respective identical and symmetrical extensions 142, 142′, positioned downstream of the fixed blade 300, oriented upwards and that with their upper end are articulated to pivot pins 46, 46′ constrained to the side members 101, 101′ of the base 1, these pivot pins being axially aligned with each other and being parallel to the same fixed blade 300. The axes of the pivot pins 46, 46′ are positioned on an ideal horizontal plane on which the cutting edge K of the fixed blade 300 lies or is vertically positioned at a short distance and the same pivot pins 46, 46′ are horizontally positioned at a short distance from the same cutting edge K. The outer plates 42, 42′ have, in the lower part thereof, respective identical and symmetrical appendages 242, 242′ that extend downwards, below the height of the small brackets 45, 45′ and on the lower ends of which there are fixed perpendicularly identical pins 47, oriented one in the direction of the other, positioned with the axis on a common ideal plane that also contains the upper pivot pins 46, 46′ and that is spaced by a few degrees from the verticality, for example by around 7-10 degrees. As the distance between the pins 47 and related pivot pins 46, 46′ is almost seven or eight times greater than the horizontal distance between the same pivot pins 46, 46′ and the cutting edge K of the fixed blade 300, a large movement imparted to the same pins 47 translates into a very small movement of the cutting blade K of the same fixed blade 300, useful for the purposes indicated above. With reference to FIG. 2 and also to the details of FIG. 11, it can be seen that the pins 47 cooperate with respective vertically opening forks 48, which rest against said extensions 242, 242′, and which are provided on the foot with respective lead screws 49 cooperating with horizontal screws 50, orthogonal to the pins 47, rotatably supported with one end by bushings 512 fixed to a lower cross member 201 of the main base frame 1 and that with the other end are connected to bevel gearboxes 52, in turn supported by the other lower cross member 201 of the same main frame 1, which are interconnected by a synchroniser shaft 53 and at least one of which is provided with a manual power take of 54 usable through large lateral vertical slots 55 (see FIG. 11) provided on a secondary base frame 56, for example of the packaging machine that uses the sheets obtained from the transverse cut of the web N by the device in question and that supports the means for feeding to the same device the web N unwound from a reel (see below). After adjustment of the fixed blade 300 through the power take off 54, which causes a movement of the cutting edge K of this blade into conditions of perfect parallelism with respect to the common axis of the pins 46, 46′, the oscillating plates 42, 42′ are blocked against the side members 101, 101′ of the main base 1 (see also FIG. 3), by means of screws 57, 57′ screwed into the same plates 42, 42′ and that pass through the slotted holes 58, 58′ obtained on the side members 101, 101′ and having the shape of a circle sector, with centre of curvature on the pivot pins 46, 46′. It is evident that to be able to make the aforesaid adjustment through the power take off 54, said screws 47, 47′ must first be loosened.

From FIGS. 1 and 11 it can be seen that on the inner faces of the side members of the secondary base frame 56, there are fixed with their upper wing substantially coplanar to the lower side of the slots 55, sturdy brackets 59, 59′ with L-shaped profile. The cutting device according to the invention rests with the side members 101, 101′ of its main base 1 on the upper wing of the brackets 59, 59′ and this wing is provided longitudinally with slotted holes 60 through which there pass screws 61 screwed into corresponding threaded holes provided on the ends of the cross members 201 of the base 1 of the same device. By exploiting sufficient transverse clearance existing between the shank of the screws 61 and the corresponding slotted holes 60 and by means of screw and lead screw adjusters 63, 63′ provided on opposite transverse sides of the brackets 59, 59′ and such as to interact with their screw perpendicularly on opposite sides of the side members 101, 101′ of the main base 1, it is possible perform adjustment of the transverse orientation of the cutting device in question with rotation on the vertical axis H, mentioned previously with reference to the arrows A, A′ of FIG. 10, to ensure the necessary transversality in the execution of the cut T on the web N moving in the direction of the arrow F.

In FIG. 2 the number 64 indicates a plane with T-shaped profile, fixed to the side members 101, 101′ of the main base 1 of the device, which guides the web N to be cut correctly between the rotary blade assembly 20 and the fixed blade assembly 300 of the same device in question, with an orientation tangential to the orbit 29 of rotation of the upper blade 20, it being provided that the same web N comes from a pair of driving rollers 65, 65′, the lower 65 of which has a large diameter, has a surface with a high coefficient of friction on the web N, is motorized and is affected by the same web N for a large section of its circumference, due to guiding of the same web N on an idle roller 66 below. All the rollers considered above and all the means that control unwinding of the web N to be cut from the reel are installed on the secondary base frame 56.

From FIGS. 1, 2 and 11 it is evident how, due to the presence of eyebolts 9 and to the large passages offered by the vertical slots 55 of the secondary base 56, it is possible to perform quick installation and removal of the cutting device in question on and from the packaging machine, to allow quick replacement with a pre-adjusted device and to allow the same packaging machine to quickly restart its work cycle, while the device removed can easily be subjected to the necessary maintenance so that it is ready for use when a new change is required in the future.

It is understood that the description refers to a preferred embodiment of the invention, to which numerous variants and construction changes can be made, all without departing from the informing principle of the invention, as described, illustrated and as claimed below. In the claims, the references indicated in brackets are purely indicative and do not limit the scope of protection of these claims.

1. Device with quick change blades for the transverse cutting or perforation, for the whole of the width and progressively, of continuous and moving webs of paper, plastic or other materials, also with different thicknesses, provided with a fixed blade assembly and a rotary blade assembly between which the web is guided transversely by a sliding plane and is fed longitudinally by suitable driving and thrust means characterised in that the same fixed blade assembly and rotary blade assembly are installed on the side members of a main base frame, with the drive means and with the means for adjusting the parallelism and the degree of interference between said two blades, said main base frame being installed removably on a secondary base frame, with means for adjusting the transverse alignment of the same main frame with the blade assemblies with respect to the longitudinal axis of the web to be cut, to allow dynamic execution on this web of a cut perpendicular to the longitudinal sides of the same web, this device being provided with means that allow quick installation and, when necessary, replacement with a new device each time both said blades require in-depth maintenance and adjustments, all for the purpose of limiting the downtimes of the packaging machine during replacement of the same device.

2. Device according to claim 1, wherein said main base frame rests with its side members on brackets fixed to the lower side of large vertical slots provided on the side members of the secondary base frame, said brackets being provided with longitudinal slotted holes through which there pass screws screwed into corresponding threaded holes provided under the main base of the same device, all so that by exploiting sufficient transverse clearance existing between the shank of said screws and the corresponding slotted holes or by exploiting a suitable curved form of the same slotted holes and acting on screw and lead screw adjusters provided on opposite transverse sides of said brackets and such as to interact with their screw perpendicularly on opposite sides of the same main base, it is possible to adjust the transverse orientation of the cutting device in question with rotation thereof on a vertical axis passing through the centreline of the same cutting device, so that it can make cuts on the moving web perpendicular to the longitudinal sides of the same web.

3. Device according to claim 2, wherein the rotary blade assembly is placed over the fixed blade assembly and is provided with a sturdy rectilinear body with end hubs rotatably supported by the side members of the main base, by means of respective bearing cases, eyebolts being installed on one face of said body to facilitate handling of the whole device in question in the installation and removal steps, while on the face opposite the one with the eyebolts, said body carries a removable blade with a cutting edge with helical extension and with centre of curvature on the rotation axis of said hubs, one of which passes through its bearing case and is connected with interposing of a safety joint to a rotation gear motor, preferably with electric motor for electronic speed and phase control, supported on a bracket fixed to the nearby side member of said main base frame and which projects through one of said large vertical slots of said secondary base frame.

4. Device according to claim 3, wherein said fixed blade assembly is provided with a sturdy rectilinear body on the face of which oriented towards the rotary blade assembly above there is removably installed a fixed blade with a rectilinear cutting edge, said body being provided at the opposite ends with respective transverse horizontal holes for articulation by means of respective pins to the upper end of corresponding vertical slides installed on related outer supporting plates, with the possibility of independent and selective adjustment of the position in height of said slides, through guiding and blocking systems with slotted holes and screws and by means of screw and lead screw height adjusters that interact between the same slides and the small brackets below integral with said outer plates, all being provided to be able to ensure a rigorously precise and “parallel” arrangement between the rectilinear cutting edge of the fixed blade in relation to the plan projection of the helical cutting edge of the rotary blade, even in the absence of high precision in the machining of the main base frame and in the installation thereon of all the parts that support the same fixed blade.

5. Device according to claim 4, wherein said outer plates are provided on the top part thereof with respective identical and symmetrical extensions, positioned downstream of the fixed blade, oriented upwards and that with their upper end are articulated on pivot pins constrained to the side members of the main base, these pivot pins being aligned with each other axially, being parallel to the same fixed blade, being positioned on an ideal horizontal plane on which the cutting edge of the fixed blade substantially lies and being horizontally positioned at a short distance from the same cutting edge, said outer plates being provided in the lower part thereof with respective identical and symmetrical appendages that extend downwards, below the height of said small brackets and on the lower ends of these appendage there are fixed perpendicularly identical pins, oriented one in the direction of the other, positioned with the axis on a common ideal plane that also contains the upper pivot pins and that is spaced by a few degrees from the verticality, for example by around 7-10 degrees, it being provided that there cooperate with said pins respective vertically opening forks, which rest against said extensions and are provided on the foot with respective lead screws cooperating with horizontal screws, orthogonal to the pins, rotatably supported with one end by bushings fixed to a lower cross member of the main base frame and that with the other end are connected to bevel gearboxes, supported by the other lower cross member of the same main frame, these gearboxes being interconnected by a synchroniser shaft and at least one of the same gearboxes being provided with a manual power take off usable through one of the large lateral vertical slots provided on said secondary base frame, it being provided that through this power take off it is possible to adjust the degree of interference of the lower blade with respect to the upper rotary blade, to be able to adapt the cutting device in question to act on webs of different thickness and/or different materials and to take up wear on the same blades.

6. Device according to claim 5, characterised in that, after adjustment of the fixed blade by means of said power take off, it is possible to block said oscillating plates against the side members of the main base, by means of screws screwed into the same oscillating plates, which pass through the slotted holes obtained on said side members and having the shape of a circle sector, with centre of curvature on said pivot pins, the head of said screws being positioned on the outer faces of said side members that are exposed through said large vertical slots of said secondary base frame.

7. Device according to claim 3, wherein both said blades are installed on respective rectilinear holder blocks that can be inserted with high precision into longitudinal channels of said respective supporting bodies in which the same holder blocks can be fixed and released quickly and securely by means of respective mushroom shaped clamping bolts stressed towards the release position by respective springs and that can be blocked with screw and lead screw means at least for the holder block with rotary blade, while for the holder blocker of the fixed blade they can be fixed by means of eccentric levers, it being provided that the head of said mushroom shaped bolts is prevented from rotating by suitable means and it being provided that in the blocked position they cooperate with friction with parts with a C-shaped profile of the lower and grooved profile of said holder blocks with said blades, all so as to allow quick replacement of the same blocks with the blades each time the blades become worn during operation.

8. Device according to claim 6, characterised in that when the holder block with the rotary blade is in the highest angular position of its rotation orbit, the same holder body is positioned over the side members of the main base frame, so as to be able to easily replace said holder block with a longitudinal removal movement, without interfering with the same main base, while the holder body with the fixed blade is provided at one end with a cantilevered handle that passes through an opening of the nearby side member of the main base, all so as to be usable also through one of the large vertical slots of said secondary base.

9. Device according to claim 7, wherein said rectilinear holder blocks of the rotary blade and of the fixed blade support these blades by means of an intermediate flattened surface and a subsequent lowered flattened surface on which there is arranged a strip of elastomeric material that is arranged substantially coplanar to said flattened surface and that with this forms the support for the transversely unexposed section of the blade, said intermediate flattened surface being preceding by a flattened surface that is substantially coplanar to the exposed face of the blade and that forms the abutment step for the non-operating edge of the same blade and the same flattened surface is followed by a raised flattened surface resting on which is the longitudinal side of a metal pressure plate that overlaps and pinches the blade on the intermediate flattened surface and to a lesser extent also on the insert, with the interposing of an elastomeric strip with greater rigidity than the opposed insert, it being provided that said flattened surface is provided with a plurality of threaded holes distributed adequately spaced from one another on the whole of the length of the holder blocks and there being screwed into these holes the shanks of screws that pass through corresponding through holes of the clamping plate, it being provided that due to the presence of said inserts made of elastomeric material, the blades can react in an elastic and non-traumatic way to the stresses deriving from mutual cooperation and cooperation with the web to be cut.
